(19) United States
(12) Patent Application Publication
(10) Pub. No.: US 2014/0015773 A1
(43) Pub. Date: Jan. 16, 2014

(54) HAPTIC SENSATION FOR TOUCH-SCREEN INTERFACES

(71) Applicant: Thomson Licensing, (US)

(72) Inventor: Markus Eugen LOEFFLER, Altedena, CA (US)

(73) Assignee: Thomson Licensing, Issy de Moulineaux (FR)

(21) Appl. No.: 13/727,809

(22) Filed: Dec. 27, 2012

Related U.S. Application Data
(60) Provisional application No. 61/602,815, filed on Feb. 24, 2012.

(51) Int. Cl. G06F 3/01

(52) U.S. Cl. CPC G06F 3/016
USPC 345/173

(57) ABSTRACT

A method and system of remotely controlling a second device with a first device is provided. A haptic touch-screen control is configured on a touch-screen of the first device to remotely control an operation of the second device. The haptic touch-screen control has a surface that overlays a display of the first device and indicates a positioning of control icons on the display. The position of the control icons is identified using the haptic touch-screen control. Operation of the second device is controlled using the haptic touch-screen control to activate the control icons displayed on the touch screen of the first device. The adjustment is performed without viewing the display of the first device. A result of the adjustment of the second device is observed simultaneously with the controlling.

### CROSS REFERENCE TO RELATED APPLICATION

This application claims priority to U.S. Provisional Application No. 61/602,815 entitled “Haptic Sensation for Touch Interfaces”, filed on 24 Feb. 2012, which is hereby incorporated by reference in its entirety for all purposes.

### FIELD

The present invention relates to user interfaces. Specifically, the invention relates to a system and method that creates a haptic sensation to touch screen interfaces enabling use of the touch screen interface to control and view images displayed on another screen.

### BACKGROUND

The key problem with touch interfaces is that the user has to look at virtual controls while using them. For example, in color correction the colorist has to watch the image while they are altering the colors. Classic interfaces such as trackballs and faders enable a user to view the images being altered instead of having to view the controller. However, this is not possible with touch interfaces such as a touch screen. As the controls on touch interfaces have no perceptible touch sensation to distinguish the control icon from the remainder of the interface screen, the user is unable to operate the controls without looking at them.

### SUMMARY

This summary presents a simplified description of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

A method and system of remotely controlling a second device with a first device is provided. A haptic touch-screen control is configured on a touch-screen of the first device to remotely control an operation of the second device. The haptic touch-screen control has a surface that overlays a display of the first device and indicates a positioning of control icons on the display. The position of the control icons is identified using the haptic touch-screen control. Operation of the second device is controlled using the haptic touch-screen control to activate the control icons displayed on the touch screen of the first device. The adjustment is performed without viewing the display of the first device. A result of the adjustment of the second device is observed simultaneously with the controlling.

To the accomplishment of the foregoing and related ends, certain illustrative aspects of embodiments are described herein in connection with the following description and the annexed drawings. These aspects are indicative, however, of but a few of the various ways in which the principles of the subject matter can be employed, and the subject matter is intended to include all such aspects and their equivalents. Other advantages and novel features of the subject matter can become apparent from the following detailed description when considered in conjunction with the drawings.

### BRIEF DESCRIPTION OF THE DRAWINGS

FIG. 1 is an illustration of a system for controlling editing of an image on a display by a device including a touch interface having haptic sensory elements thereon in accordance with an aspect of an embodiment;

FIG. 2 is an illustration of a touch interface including haptic sensory elements thereon in accordance with an aspect of an embodiment;

FIG. 3 is an illustration of a touch interface including haptic sensory elements thereon in accordance with an aspect of an embodiment, the touch interface being turned on to display control icons;

FIG. 4 is an illustration of a film including haptic sensory elements thereon in accordance with an aspect of an embodiment;

FIG. 5 is an illustration of a film including cut out portions thereon in accordance with an aspect of an embodiment;

FIG. 6A-6D are illustrations of film elements for positioning over control icons on a display in accordance with an aspect of an embodiment; and

FIG. 7 is a flow diagram detailing an exemplary operation according to aspects of the invention.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It can be evident, however, that subject matter embodiments can be practiced without all of these specific details. In other instances, well-known structures and devices are shown in block diagram form in order to facilitate describing the embodiments.

Haptic sensation is a sensation of touch. Typical touch screen devices have a flat surface wherein the major haptic sensation is smoothness of the touch screen surface. The present invention introduces a different haptic sensation to a touch screen interface. The general use of haptic interfaces for the visually impaired is known. One example is Braile encoded surfaces. However, the use of a haptic sensation for a touch screen interface device to be used by a sighted individual to control a visual operation displayed on another device is new.

The inventors have determined that in order to use a touch screen interface with a program or application for which it is necessary to view an image on a screen or display other than the touch screen interface, it is necessary to adapt the controls on the touch screen interface to be perceptible to the sense of touch. Adding a haptic sensation to touch interfaces provides a user the freedom to look away from the virtual controls and at the image being edited. By providing a haptic sensation to the virtual control icons, the user is able to detect the position of virtual control icons on a touch screen interface and distinguish the virtual control icons from the remainder of the touch screen interface. This allows the user to operate the virtual controls successfully using the sense of touch without the need to look at the touch screen interface to locate and properly operate the control icons. With the haptic sensation provided to the control icons on touch interfaces, programs and applications that require viewing of an image on a device or in a location remote from the virtual controls of the touch interface can now be used with touch screen interfaces.

In a system that a employs touch screen device such as a tablet computer or smart phone, a film having regions designed and developed to be either removably or permanently applied to the screen of the device may be provided. The film may include a tactile raised surface within the regions. Alternatively the film may include a recess in cut-out regions thereby creating a tactilely perceptible contour when the film is applied to a touch screen and a finger (digit) is moved across the film passing over the recess. The film can be transparent, translucent or have at least some transparent or translucent region and include at least some cut regions. When produced for use with specific programs or applications with defined positions for the control icons, the film may include identifying images corresponding to the positions of the control icons on a screen. The system is intended to provide a haptic sensation, other than just smoothness of the touch screen surface, when operating a tablet computer or other touch screen device in which different regions of the film identify different controls or functions associated with a particular program or application and align with respective control icons on the display of the touch screen device. The invention can be used with devices such as the iPad™, iPhone™ or other smart phone or tablet device.

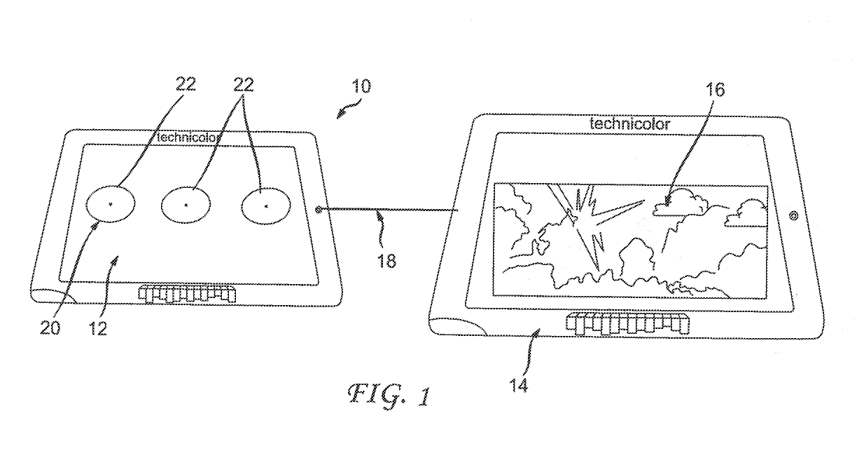

The system according to an embodiment is shown in FIG. 1. The system includes a touch screen device 10. The touch screen device 10 includes a touch screen 12 on which icons or control widgets are used to control a program or application being run are displayed. The touch screen device 10 may be connected to a further device 14 including a display 16. The connection may be wireless or via a connection wire 18. When an application program stored on the touch screen device 10 or further device 14 is running, control icons 20 are generated and displayed on the display 12 of the touch screen device 10. As the display screen 12 of a touch screen device 10 is smooth and flat, in order to identify the position of the control icons, a user must look at the display screen 12. In one embodiment, tactile elements 22 creating a haptic sensation surface are provided on a film in shapes corresponding to the shapes of the control icons or widgets 20 displayed on the display of the touch screen. The film may be of transparent, translucent or semi-transparent material thereby allowing the control icons to be visible therethrough. Alternatively, the film may have indicia printed on the tactile elements 22 and aligned with the position of the control icons generated by the program or application to identify the control icons. When the film is positioned atop the display screen 12, the tactile elements 22 are aligned closely with the displayed control icons and create a surface providing a haptic sensation surface for the fingers of a user to control operation of the application. The haptic sensation surface created by the tactile elements allow a user to determine the position of the control icons on the display screen 12 and thus control the application using their fingers without the need to look at the display screen 12. The user is thus able to view an image on the further screen 14 being edited or manipulated using the application.

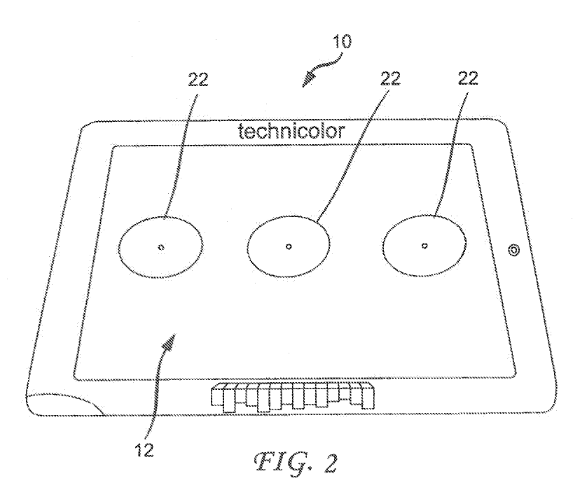

FIG. 2 shows a tablet device 10 including a touch screen 12 and having three circular tactile elements 22 cut from an adhesive transparent film and glued or removably adhered to a surface of the touch screen 12 of the tablet computer or other touch screen device. The tablet device 10 is shown in FIG. 2 in the off state so that no control icons are displayed. Such a feature in which the tactile elements 22 are horizontally aligned as shown in FIG. 2 can be useful for applications in which the user wants a 9-axis controller for performing color correction such as with Technicolor's DP Lights™ post production video processing technology. This exclusive Technicolor system can be deployed as a pre-visualization, on-location color correction tool, or used in a unique configuration to drive high quality rear screen projection. The individual tactile elements can assist the user in easily identifying the appropriate axis control without looking at the touch sensitive screen when the film is applied. The tactile elements 22 may be cut into any shape desired and preferably are of a shape corresponding to the respective control icon displayed on the touch screen 12 over which each tactile element 22 will be positioned. Additionally, the tactile elements may be used to identify the position of control icons generated by any application or program.

In one useful embodiment, the tactile elements on a touch screen can help to support 2D or 3D digital capture and enable real-time creation of pre-visualization looks during commercial production. Use of the tactile elements on a touch screen device on a video editor can further enhance color correction activities and other aspects of the viewing experience by allowing editing and color correction of images using controls on a touch screen device by eliminating the need to view the touch screen device during editing or color correction. Thus, the invention allows the editing user full concentration on the object of the editing without requiring the editing user to view the controls on the touch screen editing device. The use of films that create a haptic sensation surface on the touch screen device make possible this type of uninterrupted visual editing.

Essentially, different adhesive films can be designed that are commensurate with activities that are employed to achieve and/or enhance the capabilities of any application or program being run with the system according to invention principles.

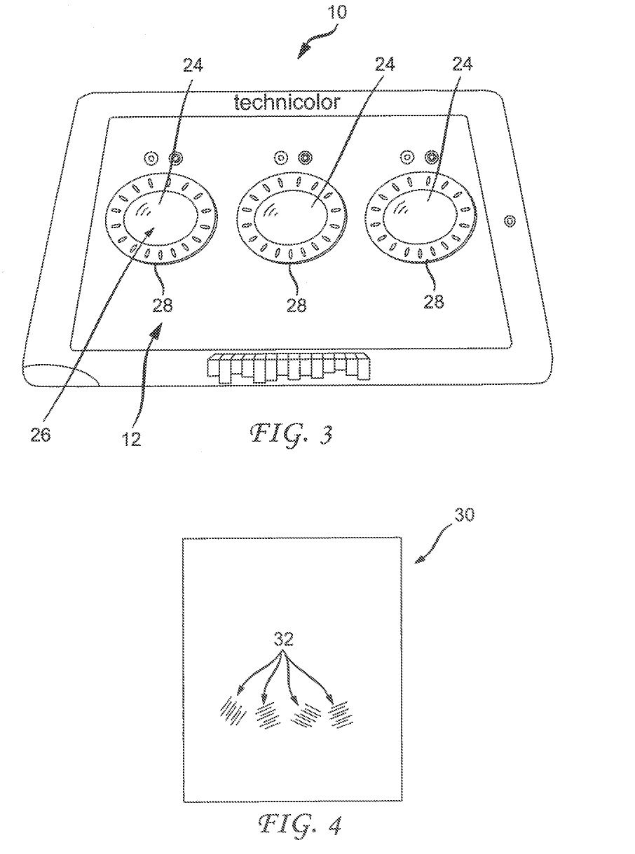

With the three circles applied to the surface in the one example, it is possible for the user to find the virtual controls (for a 9-axis color correction controller) without looking at the touch screen. FIG. 3 shows the example with the touch screen turned on. FIG. 3 shows an example of control icons 24 on the display screen 12 when the device 10 is turned on. The control icons 24 are shown to include a first control element in the form of a circular center section 26 and second control element in the form of an outer ring 28 surrounding the circular center section 26. In the arrangement shown individual sections of film including tactile elements 22 may be positioned atop and glued or releasably adhered to the areas on the display screen on which the circular center sections 26 are positioned. Thus, when a user's fingers move over the surface of the tactile element 22, the user is readily able to detect the circular center section 26. It is also readily determinable when the user's finger moves off the tactile element and on to the outer ring 28 surrounding the circular center section 26. Alternatively, the tactile element 22 can be positioned atop the outer ring 28 and not covering the circular center section 26 or having a first thickness at the position covering the circular center section 26 and a second thickness covering the outer ring 28. By distinguishing the thicknesses of the film over the different sections of the control icons, a user is able to distinguish when the fingers move from one control icon to another on the touch screen. The display of a control icon having a circular center section and an outer ring is for purposes of example only and, in practice, the control icon(s) can be of any shape and dimensions necessary for operation of the application or program being run.

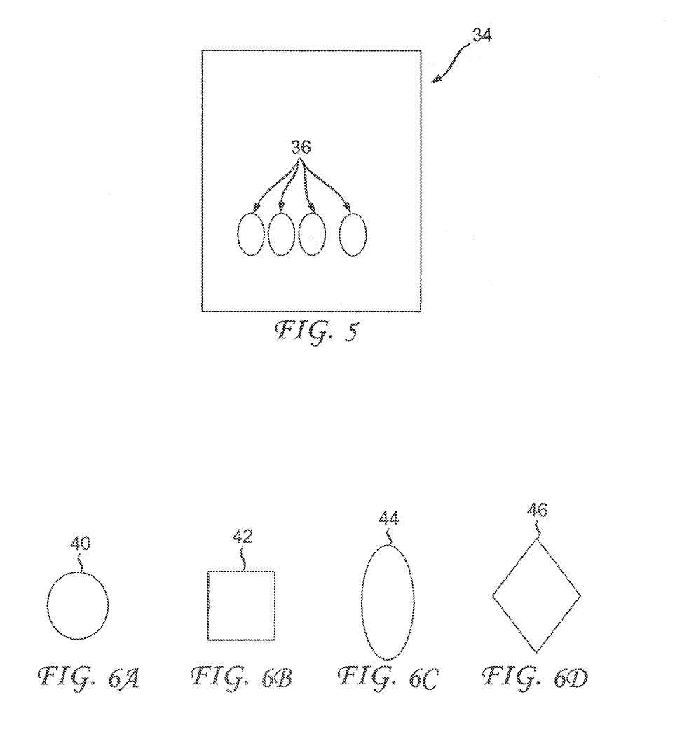

In an embodiment, a user interface screen is provided that has a generally flat patterned adhesive transparent layover or film layer on it that has a contour detectable by touch. The film may be produced to cover the entire screen with tactile or contoured sections covering the positions on the interface screen on which control icons will be displayed for a particular program or application. The patterned contour or tactile element 22 is such that it enables a user to readily identify where user controls are located on the screen without the user having to look at the user interface screen. This enables the user to make changes or perform actions on work product through the user interface while looking at the work product and not looking at the user controls. The invention is easily applicable to iPad™ products, iPhone™ iPod™ and other smart phone or tablet devices and the like. Films may be produced to conform to individual programs and the control icons displayed for each program. The film positioned atop the touch screen will be associated with the particular program or application being run by the system. Such films will be produced including tactile elements or other elements providing a haptic sensation surface at positions aligned with the control icons generated by a program or application with which the film is associated. Exemplary embodiments of films produced according to invention principles are shown in FIGS. 4 and 5. The embodiments shown in FIGS. 4 and 5 are for purposes of example alone and other forms of tactile elements or other means for creating a haptic sensation surface in predetermined areas of a display for a touch screen device may be provided on the film layer positioned atop the display screen.

FIG. 4 shows an embodiment of a film 30. The film 30 may be transparent, translucent or have at least some transparent or translucent region. The film 30 has a size substantially the same as the display screen on which it will be positioned. The film 30 also includes either a glue or adhesive material on one side thereof to secure or releasably adhere the film to a display of a touch screen device. The film 30 also having at least one tactile element 32 thereon in predefined positions. The tactile elements 32 are positioned on the film to align with the position at which control icons will appear on a display of a touch screen device. The film 30 will be associated with a respective program or application run by the touch screen device on which it is to be placed and the tactile elements 32 are positioned on the screen to align with control icons generated by the respective program or application with which the film is to be used. Thus a user is able to use the tactile elements 32 to readily detect the position of control icons displayed on the screen by a user using the sense of touch. The user is thereby able to control or operate the program or application being run without the need to view the display on the touch screen. The positioning of the tactile elements is thus dependent upon the program or application with which the film is designed for use. As the film 30 may be selectively removed from its attachment to the display screen, when a user has completed operation of a particular program or application, the film may be replaced by an alternate film associated with a different program or application the user may want to run subsequently.

FIG. 5 shows a further embodiment of a film 34. The film 34 shown in this figure includes at least one cut out portion 36. The film 34 may be transparent, translucent or have at least some transparent or translucent region. The film 34 has a size substantially the same as the display screen on which it will be positioned. The film 34 also includes either a glue or adhesive material on one side thereof to secure or releasably adhere the film to a display of a touch screen device. The film 34 also has a thickness. The cut out portions 36 are positioned to align with the position at which control icons will appear on a display of a touch screen device. Thus, due to the thickness of the film, a user is able to readily detect the position of control icons displayed on the screen when their finger senses the edge of the film 34 at the cut out portion 36. The user is able to control or operate the program or application being run without the need to view the display on the touch screen. The film 34 will be associated with a respective program or application run by the touch screen device on which it is to be placed and the cut out portions 36 are positioned on the screen to align with control icons generated by the respective program or application with which the film 34 is to be used. The positioning of the cut out portions 36 is thus dependent upon the program or application with which it is designed for use. As the film 34 may be selectively removed from its attachment to the display screen, when a use has completed operation of a particular program or application, the film 34 may be replaced by an alternate film associated with a different program or application the user may want to run subsequently.

The film with tactile elements or cutouts can be formed of a size and shape substantially similar to the touch screen device on which it is intended to be placed. The tactile elements or cut outs positioned on the film element may vary in size based on the type of device on which the film element is designed for use.

Instead of a film sheet having dimensions substantially similar to that of a display of a touch screen device, individual film elements may be positioned atop control icons on the display. Exemplary film elements are shown in FIGS. 6A-6D. The film elements have a size and shape substantially similar to the control icon over which it will be positioned. The film element also includes either a glue or adhesive material on one side thereof to secure or releasably adhere the film element to a display of a touch screen device. The film element also has a thickness. The individual film elements may include tactile elements thereon to enhance the haptic sensation created when a users finger slides thereon. Alternatively, the haptic sensation may be a sensation caused by the thickness of the film element as the finger of the user slides over the edge of the film element indicating a control icon is positioned therebelow. FIG. 6A shows a circular film element 40. The circular film element 40 is provided for placement over a circular control element of similar size on a display. FIG. 6B shows a square film element 42. The square film element 42 is provided for placement over a square shaped control element of similar size on a display. FIG. 6C shows an oval shaped film element 44. The oval shaped film element 44 is provided for placement over an oval shaped control element of similar size on a display. FIG. 6D shows a diamond shaped film element 46. The diamond shaped film element 46 is provided for placement over a diamond shaped control element of similar size on a display. The shape of the film elements shown in these figures are for purposes of example only. In practice, the film elements may be of any size and shape to fit over a respective control icon and allow a user to detect the position of the control icon on a display using only touch.

Alternatively, films may be produced with a plurality of individual tactile or contoured sections conforming to the different control icons displayed by any particular program or application. The individual tactile or contoured sections may then be individually aligned with the displayed icons and glued or removably adhered to the display screen when running the program or application.

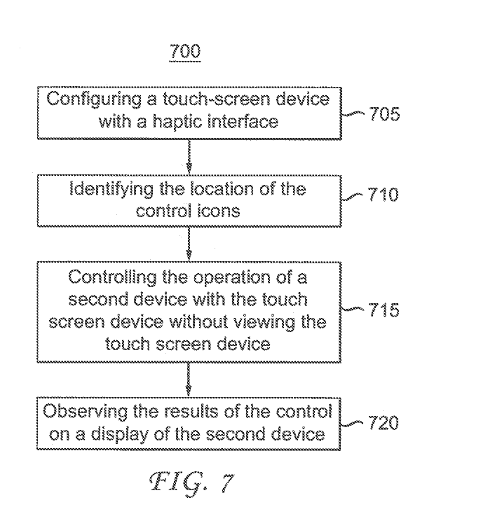

FIG. 7 illustrates an example method 700 according to aspects of the invention. At step 705, a first device, having a touch screen interface is configured with a haptic interface. Configuring the haptic interface to provide a tactile sensation for the touch screen interface allows the touch screen interface of the first device to act as a remote control for a second device. The haptic interface of the touch screen device has overlays, either a full screen film with cutouts or individual cut outs, that allow a user to use their sense of touch to control an icon or a widget displayed on the touch screen device.

In one embodiment configuring the touch screen device includes one or more of initializing the touch screen device, loading an application having a virtual control (Icon or widget) onto the touch screen device, and placing a film (full screen or piece-wise) to the surface of the touch screen device to create a haptic sensation for a user who uses a finger to follow the contours of the film placed over the icon or widget control displayed on the touch screen device.

At step 710, a user identifies a location of the control on the touch screen device. Here, the location or position of the film on the touch screen device is used to orient the user to a position of control of an icon or widget control displayed by the touch screen device. Once known, the haptic sensation of the film placed on the touch screen device informs the user of the location of the control.

At step 715, the operation of a second device, such as a video editor device, is controlled from the touch screen of the first device using the haptic sensation interface provided by the film overlay. The controlling operation is performed by a user using the haptic interface of the touch screen device without viewing the touch screen device having the hatpic interface. This “eyes-free” operation of the second device using the haptic interface of the first (touch screen) device is possible because the haptic interface allows the user to operate the controls without viewing the touch screen controls. This is of interest to sighted viewers who have a need to control a visible expression or operation of a second device, such as a video editor, without looking at the touch screen interface of the controlling device.

At step 720, the user is able to observe the results of the controlling operation. Here, the user observes the resultant visual effects that the controls on the first touch screen device have on the display of the second device. In one aspect of the invention, such a visual display on the second device demonstrates the real-time effect that the touch screen controls have on the display item of the second screen. In effect, the result of the visual display of the second device is in direct correspondence and is simultaneous with the user actuating the controls of the first device having the haptic sensation touch screen.

In one embodiment, the first device is a touch screen device and the second device is a video editing device having a display that presents real-time edit results to a user. Once again, a simultaneous action/result is observed by the user viewing the display of the second screen without viewing the controls on the touch screen interface device. This allows the user to concentrate their gaze upon the second screen completely and not view the first device with the touch screen interface while the control icons and widgets of the first device are being operated. The tactile feedback (i.e. haptic sensation feedback) provided by the touch screen interface allows the user to operate the second screen editing without removing the gaze of their eyes from the display of the second screen.

In summary, a haptic sensation touch-screen interface system is provided that includes a first display having a haptic sensation touch screen surface interface with a generally flat patterned adhesive transparent layover or film that permits a user to identify control setting icons through touch and a second display which displays images of work product that is altered by adjustments made through use of the haptic sensation touch screen surface interface.

What has been described above includes examples of the embodiments. It is, of course, not possible to describe every conceivable combination of components or methodologies for purposes of describing the embodiments, but one of ordinary skill in the art can recognize that many further combinations and permutations of the embodiments are possible. Accordingly, the subject matter is intended to embrace all such alterations, modifications and variations that fall within the spirit and scope of the appended claims.

1. A method of remotely controlling a second device with a first device, the method comprising:
configuring a haptic touch-screen control on a touch-screen of the first device to remotely control an operation of the second device, the haptic touch-screen control having a surface that overlays a display of the first device and indicates a positioning of control icons on the display;
identifying the position of the control icons using the haptic touch-screen control;
controlling operation of the second device using the haptic touch-screen control to activate the control icons displayed on the touch screen of the first device, the adjustment performed without viewing the display of the first device;
observing a result of the adjustment of the second device, the observing performed simultaneous with the controlling.

2. The method of claim 1, wherein configuring a touch-screen device comprises at least one of:
(a) initializing the touch-screen device;
(b) loading an application having a virtual control onto the touch screen device; and
(c) placing a film including at least one surface creating a haptic sensation onto the touch-screen control of the touch-screen device.

3. The method of claim 1, wherein controlling operation comprises moving a finger along the haptic touch-screen control, the adjustment performed without viewing the touch-screen control.

4. The method of claim 1, wherein the haptic touch screen control includes at least one of a tactile surface or cut out section in a position aligned with the control icons on the display.

5. The method of claim 3, wherein moving a finger along the haptic touch-screen control provides tactile feedback to an operator controlling the operation.

6. The method of claim 1, wherein observing a result comprises viewing the result of the operation by an operator controlling the operation.

7. An apparatus to remotely control an operation, the apparatus comprising:
a first device including a touch-screen interface having a display;
an overlay positioned on top of the touch-screen interface, the overlay including a surface indicating a position of control icons on the display of the touch-screen interface and enabling actuation of the control icons without viewing the display of the touch screen interface;
a second device;
a communication interface to transmit a control instruction from the touch-screen interface to the second device wherein operation of the second device is controlled in response to the control instruction;
wherein a result of the operation of the second device is observed real-time by an operator without viewing the display on the touch-screen interface, and the result of the operation is observed simultaneously with actuation of the control.

8. The apparatus of claim 7, wherein the display is a flat-screen display of a tablet computer or smart phone that is separate from the second device.

9. The apparatus of claim 7, wherein the overlay includes one of a tactile surface or cut out portion acting to guide a finger of the operator to actuate the control without viewing the display of the touch-screen interface.

10. The apparatus of claim 7, wherein the communication interface is a wireless interface.

11. A method of remotely controlling a video editor device, the method comprising:
configuring a touch-screen control displayed on a touch-screen device to remotely adjust an operation of the video editor device, the touch-screen control having a haptic sensation surface that overlays a display of the touch-screen device and indicates a positioning of control icons on the display;
identifying the position of the control icons using the touch-screen control;
performing an adjustment of the video editor device using the touch-screen control to activate the control icons on the display of the touch-screen device, the adjustment performed without viewing the display of the touch-screen device; and
observing a result of the adjustment on a display of the video editor, the observing performed simultaneously with the adjustment.

12. The method of claim 11, wherein configuring a touch-screen device comprises at least one of:
(a) initializing the touch-screen device;
(b) loading an application having a virtual control onto the touch screen device; and
(c) placing a film including at least one surface creating the haptic sensation surface onto the touch-screen control of the touch-screen device.

13. The method of claim 11, wherein performing an adjustment comprises moving a finger along the haptic sensation surface of the touch-screen control indicating a positioning of control icons on the display, the adjustment performed without viewing the touch-screen control.

14. The method of claim 11, wherein the haptic sensation surface of the touch screen control includes at least one of a tactile raised surface or tactile cut-out section in a position aligned with the control icons.

15. The method of claim 13, wherein moving a finger along the haptic sensation surface provides haptic sensation feedback to an operator performing the adjustment.

16. The method of claim 11, wherein observing a result comprises viewing the result of the adjustment by an operator performing the adjustment.

17. An apparatus to remotely control a video editor device, the apparatus comprising:
a touch-screen interface having a display of a control for the video editor device;
a tactile overlay positioned on top of the control that is displayed on the touch-screen interface, the tactile overlay enabling actuation of the control without viewing the display of the control on the touch screen interface;
a communication interface to transmit a control instruction from the touch screen interface to the video editor device wherein an adjustment of the video editor is performed;
wherein a result of the adjustment is observed real-time on a display of the video editor device without viewing the control on the touch-screen interface, and the result of the adjustment is observed on the display of the video editor device simultaneously with actuation of the control.

18. The apparatus of claim 17, wherein the touch-screen interface is a flat-screen display of a tablet computer or smart phone that is separate from the display of the video editor device.

19. The apparatus of claim 17, wherein the tactile overlay acts to guide a finger of an operator to actuate the control without viewing the control.

20. The apparatus of claim 17, wherein the communication interface is a wireless interface.
